(19) United States
(12) Patent Application Publication
(10) Pub. No.: US 2009/0268909 A1
(43) Pub. Date: Oct. 29, 2009

(54) METHOD FOR OPERATING A WIRELESS SENSOR NETWORK

(75) Inventors: Joao Girao, Leimen (DE); Miguel Martin Lopez, Ludwigshafen (DE)

Correspondence Address: YOUNG & THOMPSON, 209 Madison Street, Suite 500, ALEXANDRIA, VA, 22314, US

(73) Assignee: NEC EUROPE LTD., Heidelberg (DE)

(21) Appl. No.: 12/304,551

(22) PCT Filed: Jun. 6, 2007
(86) PCT No.: PCT/EP2007/005046

§ 371 Date: Feb. 4, 2009

(30) Foreign Application Priority Data
Jun. 12, 2006 (DE) 10 2006 027462.8

(51) Int. Cl. H04L 9/08; H04K 1/10; H04L 9/00

(52) U.S. Cl. 380/259; 380/33; 380/274; 380/30; 380/283

(57) ABSTRACT

A method for operating a wireless sensor network, wherein the sensor network includes a multitude of distributed sensor nodes for sensing data within a pre-definable environment, and wherein the sensor nodes can exchange information via encrypted data transmissions over a radio Channel is—regarding the fact that during the operational phase of the network the Performance of changes in the network, in particular the composition of the sensor nodes that are integrated in the network, is allowed in a flexible way—characterized in that a subset of sensor nodes of the network is manipulated in order to establish a shared secret (x) by transferring a defined information to the sensor nodes of the subset over a secure out of band (OOB) Channel.

The present invention relates to method for operating a wireless sensor network, wherein the sensor network comprises a multitude of sensor nodes for sensing data, the sensor nodes being distributed within a pre-definable environment, and wherein the sensor nodes can exchange information among each other via encrypted data transmissions over a radio channel.

Methods of the present kind have been known in practice for some time, because sensor networks have been gaining importance and are being applied in particular in the area of environmental monitoring, for example to analyze weather, humidity distributions or contamination of water, or to measure the temperature of surfaces, to track movement patterns, to control big industrial sites etc. The list of possible fields of application could be extended almost arbitrarily.

The individual sensors of a sensor network are sensor nodes that communicate in a wireless way with each other and that, in general, consist of a sensing element, a processing unit, a communication device and an energy source—for example a battery or solar cells. Functionalities of data acquisition, communication and computation are combined in the sensor nodes on a very small space. This miniature design is extremely advantageous for specific applications, for example, said environment monitoring, because it enables the deployment of the sensor nodes, and consequently an application of the network, also in areas that are hard to access.

Critical parameters, which possibly could restrict the possible fields of application of sensor networks, are in particular given physical values of the individual sensor nodes, for example, their transmission range, processor power, battery capacity, available storage capacity or the like. Due to these physical restrictions, the energy-efficient organization of the sensor network is of particular importance.

Another important aspect, which has to be taken into consideration when building up a sensor network, is a secure transmission of the data sensed by the sensor nodes. The platform forming the base of the sensor node shows in general extremely small dimensions and does in general not have a tamper resistant unit. In order to increase security of data transmission in sensor networks, the sensed data of the individual sensor nodes are generally transmitted in an encrypted form. To do so, in general a continuous encryption is chosen, i.e. the sensed data is encrypted directly at the sensor node and only decrypted after receipt at the tamper-resistant sink node (end-to-end encryption).

In particular the limited energy resources resulting from the sensor nodes being battery-powered are the reason why it is not acceptable to apply constantly asymmetric encryption methods within the network. Such an approach would cut short the lifetime of the network and make it inappropriate for most applications. Most methods for key distribution are hence based on a kind of dynamic key distribution. As soon as the sensors are deployed in an environment to be examined and the network is stable after an initialization/set-up phase, the key pool of unused keys of the master key is generally erased in the individual sensor nodes, in order to prevent that a potential attacker that has access to the hardware gains knowledge to any key, other than the one being used at the node.

In the case of the known methods it is disadvantageous that said methods are extremely inflexible during the operational phase in what respects to the performance of changes in the network. These problems occur in particular in two specific situations. On the one hand, the problems of said kind occur after a certain operational lifetime of the sensor network, i.e. when sensor nodes start breaking down due to hardware problems, failure of battery or possibly even due to physical destruction. In this case there is often a high interest on the side of the network operator to replace the harmed nodes by new nodes, in order to again strengthen the coverage of the examined environment.

In the second case the problems result from the fact that it turns out during operation that there are nodes within the network that deliver obviously wrong measurement data that in turn statistically falsify the overall measurements of the network. The wrong measurements can result, for example, from a de-calibration, from an unfortunately bad positioning when deploying the nodes (for example under a tree or in a rivulet), or from an external manipulation. In any case, the network operator will be interested in excluding the wrongly working nodes from the network.

In both described cases the possibilities for the network operator are very restricted. Due to the loss of knowledge regarding the keys used by the sensor node as described above, it is very difficult to integrate new nodes into the encrypted data transmission as established in the network or to exclude nodes of the network from such. Even in case that the knowledge about the key distribution between the nodes were still available, new nodes could hardly be integrated from the view of point of costs, because they would first of all have to be programmed according to the detailed requirements of the customer and be adapted to the used keys, in order to enable the sensor nodes to integrate into the existing network. In other words, a network operator would first have to find out which keys are currently used in the network to configure these keys then into the nodes to be newly integrated.

It is therefore an object of the present invention to specify a method for operating a wireless sensor network of the above-mentioned kind, according to which changes of the network can be performed in a flexible way during the operational phase of the network, in particular regarding the composition of the sensor nodes that are integrated into the network.

In accordance with the invention, the aforementioned object is accomplished by a method for operating a wireless sensor network comprising the features of patent claim 1. According to this claim such a method is characterized in that a subset of sensor nodes of the network is manipulated in order to establish a shared secret (x) by transferring a defined information to the sensor nodes of the subset over a secure out of band (OOB) channel.

According to the invention, it has first been recognized that during the stable operational phase, i.e. after the initialization phase during which the network organizes itself is finished, changes to the network can be realized without loss of security by using an out of band channel (OOB). The out of band channel is generally inherently secure. According to the invention, a subset of sensor nodes of the network is transferred certain information over the out of band channel. This information received by the sensor nodes is used for the establishment of a secret shared by the recipient sensor nodes. The shared secret can be generated by using a pre-definable algorithm from the received information. With the method according to the invention it is hence possible to insert a new key securely during the operational phase.

In a specifically advantageous way, the out of band channel is separated from the radio channel, so they work completely independently one from the other. This may be a logical separation from the regular data flow or a physical separation.

In the context of an advantageous embodiment it may be provided that the information is transferred to the subset of sensor nodes by exposing the sensor nodes to a pre-definable temporal sequence of optical and/or acoustic impulses. In a particularly simple way the optical impulses may be generated with a torch, and the acoustic impulses with a buzzer.

In the context of a further advantageous embodiment it may be provided that the information is transferred to the subset of sensor nodes by a movement. In case of this embodiment, the sensor nodes are designed in such a way that they can detect movements. For this purpose, the sensor nodes may be equipped, for example, with an accelerometer. When the network operator takes the subset of sensors in his hand and shakes them all together, shared information can be transferred to the subset of sensor nodes in a very simple way.

In principle, the kind of transferring information is not limited, it only needs to be ensured that the sensor is able to detect the information. When using, for example, optical impulses, the sensor nodes need to include a corresponding light-sensitive element. Against this background it can consequently be provided for transferring the information on the subset of sensor nodes in general in form of a sequence of measured values sensed by the sensor nodes. In this sense, the information could be transferred to the sensor nodes, for example, in form of measured temperature values. In such cases a certain tolerance has to be ensured, so that only variations in the measured values (for example measured temperature values) that exceed a certain threshold do result in different shared secrets, whereas small variations result in the same shared secrets.

Regarding a simple manageability, the sequence of optical and acoustic impulses or the sequence of measured values is translated into a binary sequence of numbers by the involved sensor nodes. In order to realize a uniform and well defined length and structure, it may further be provided that the binary sequence of numbers is translated into a hash value which then forms the shared secret of the involved sensor nodes.

Regarding a further increase of security, it may be provided that the sensor nodes of the network are informed by a message about a manipulation to come, wherein the message may be generated by a specific node, preferably by a sink node of the network. With this message the nodes may be informed, for example, that within the next five seconds a manipulation is to be expected. The nodes may be pre-programmed in such a manner that they would ignore a manipulation, for example in form of an irradiation of light impulses, if they had not received such an information message of the described kind in advance. By these means it can be avoided that the sensor nodes react to a manipulation attempt initiated by a malicious attacker.

Regarding an integration of new sensor nodes into the network it may be provided that the manipulation is performed on a subset of sensor nodes of the network—old nodes—as well as on the sensor nodes to be integrated newly—new nodes. Regarding a high level of security, the manipulation is preferably performed in a controlled environment. For example, the network administrator could collect some of the old nodes and expose them in his palm, together with the nodes to be newly integrated, to light from a torch.

Moreover, it may be provided that the manipulated sensor nodes authenticate among each other based on the shared secret. The authentication may be performed, for example, with a symmetric message authentication code (MAC) computed on the base of the shared secret. After the authentication is performed, the manipulated sensor nodes, based on the shared secret, can agree on a key for a secure data transmission in the context of a key exchange protocol. The manipulated old nodes, i.e. those nodes that were already integrated into the network, function consequently as a kind of bridge or interface, as they can exchange encrypted data in a secure way both with the newly integrated nodes as well as with the rest of the nodes of the network.

In the context of a concrete embodiment the key exchange is performed according to the Diffie-Hellmann algorithm. Regarding power saving, it may alternatively be provided that the key exchange is performed according to a modified Diffie-Hellmann algorithm with simplified public parameters. Instead of generating an exponential value, for example, a pure multiplication may be provided. Since the shared secret is neither transmitted in the context of the authentication nor in the context of the key agreement, the length of the secret can be chosen to be rather small. In practice a length in the range of about 20 bit should prove to be sufficient.

Regarding an exclusion of sensor nodes from the network—for example due to a malfunction or de-calibration—it proves to be advantageous to combine the information transferred to a subset of sensor nodes over the out of band channel always with a value—hereinafter called evidence—that is generated by the sensor nodes itself, in order to generate a new key for the data exchange on that base.

In the simplest form, the evidence can be a function of values sensed by the sensor node. If the measured values of a manipulated sensor node do not fall inside a certain measurement range, the evidence computed by the sensor node deviates from the evidences of other manipulated nodes, and the node hence generates a wrong key. This effectively equals an exclusion of the node from the network.

In view of a higher flexibility regarding the exclusion criteria, it may be provided that the evidence is not only a function of measured values sensed by the sensor nodes, but moreover a function of an additional parameter. In an advantageous way, the parameter is transmitted to the sensor nodes together with the information transferred to the sensor nodes over the out of band channel. The deployed parameters may refer, for example, to the time of an initial measurement that is employed for the evidence, to the number of measured values that are to be considered when computing the average value, to the width or the center of a measurement's tolerance, etc. In principle, all parameters can be envisioned that refer to values which can be employed for the refinement of exclusion criteria.

There are several ways of how to design and further develop the teaching of the present invention in an advantageous way. To this end, it is to be referred to the patent claims subordinate to patent claim 1 on the one hand and to the following explanation of preferred examples of an embodiment of the invention, illustrated by the figure on the other hand. In connection with the explanation of the preferred examples of an embodiment by the aid of the figure, generally preferred embodiments and further developments of the teaching will be explained. In the drawing,

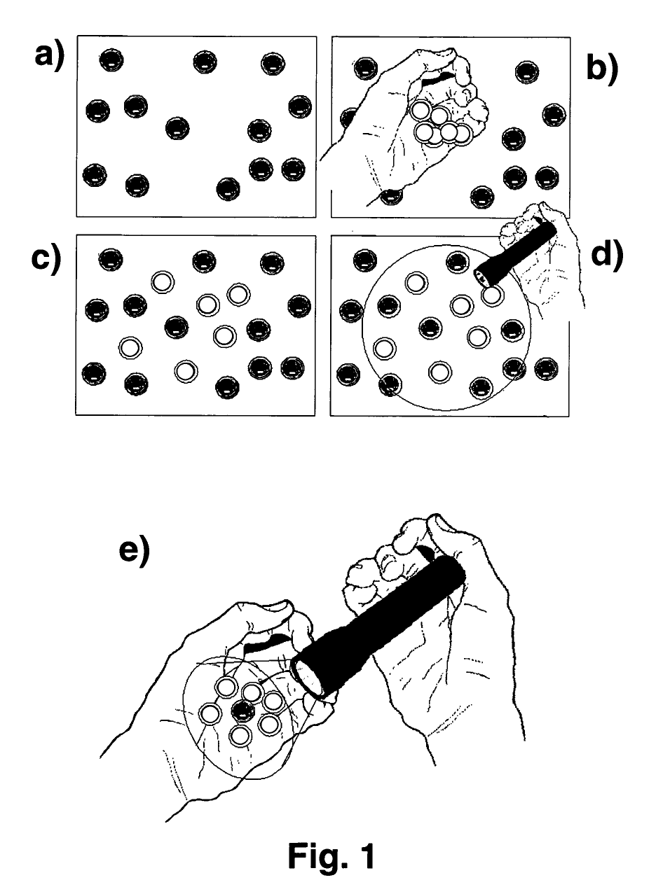

FIG. 1 shows an example of an embodiment of the method according to the invention for operating a wireless sensor network, wherein new nodes are integrated into the network,

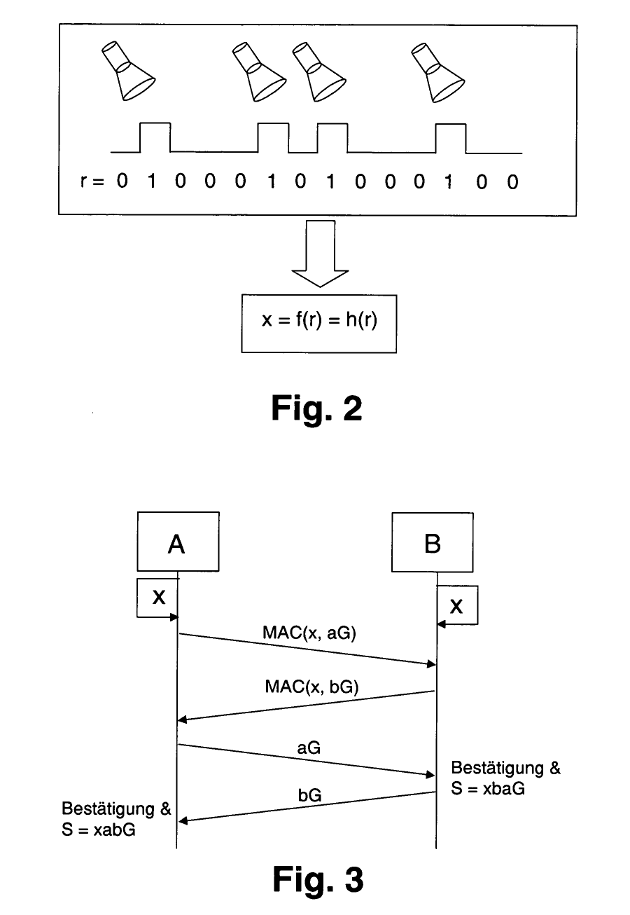

FIG. 2 shows an example of an embodiment for manipulating sensor nodes with optic impulses,

FIG. 3 shows an example of an embodiment for generating an authenticated symmetric key and

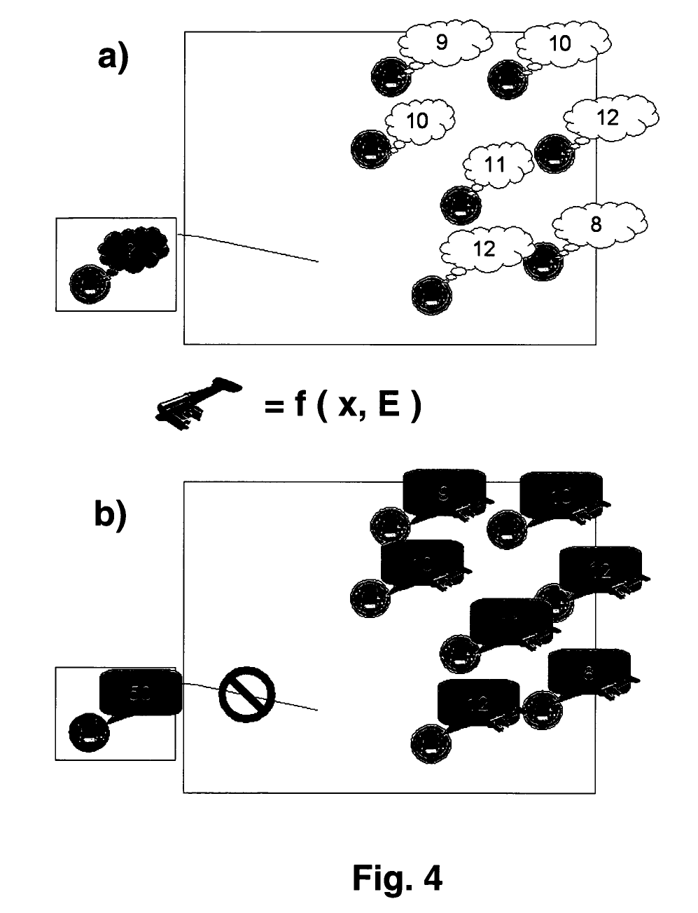

FIG. 4 shows an example of an embodiment of the method according to the invention, wherein sensor nodes are excluded from the network.

FIG. 1 shows—schematically—an example of an embodiment of a method according to the invention, in which new nodes are to be integrated into an existing sensor network. In the sensor network a multitude of sensor nodes are distributed in a pre-definable environment. In FIG. 1a) a part of the environment of the sensor network covered by the sensor nodes is depicted. The dark dots represent individual sensor nodes that are able to exchange information among each other over a radio channel. All data is—as common in practice—transmitted encrypted.

The situation as depicted in FIG. 1a) shows the network at such a moment where the network has already been running stable for a certain time. A situation can occur where nodes break down, e.g., due to hardware problems or consumption of battery, and the operator of the network judges coverage of the area as insufficient. As depicted in FIG. 1b), the operator will decide to deploy new nodes in such an area in order to improve coverage again. After deployment, the new nodes—depicted in light colors—will have mixed in a random distribution with the old nodes of the existing network, as it is depicted in FIG. 1c).

In a next step, depicted in FIG. 1d), according to the invention certain information to establish a shared secret is transferred to a subset of sensor nodes over a secure out of band channel, which is separated from the radio channel. In the depicted embodiment the out of band channel is a light-optical out of band channel. Concretely, the subset of sensor nodes is exposed to a defined temporal sequence of light impulses. The light impulses are generated by a torch. The manipulated subset includes those nodes that are within the cone of light represented in FIG. 1d). The subset includes all new nodes and some of the old nodes of the existing network. As it will be described further in detail below, the OOB message, i.e. the temporal sequence of light impulses, is used to distribute an authenticated symmetric key. The generation of the key on the base of the OOB message will be described in detail in the context of FIG. 3. After successful generation of the key the old nodes of the network that have received the light impulses act as connector or as bridge, being able to exchange encrypted data with the new nodes, as well as with the rest of the nodes of the existing network.

In FIG. 1e) a situation is depicted where the sensor nodes are exposed to the light impulses in a controlled environment, so the security of the method further increases. Moreover, together with the new nodes only one old node of the network is irradiated with light, which also serves an increase of security. If the only old node is a node that had been inserted by a malicious attacker into the network and which consequently does not dispose of a key valid in the old network, this node can hence not act as connector between the nodes to be newly integrated into the network, and the rest of the nodes of the network. Thus, when the network operator finds that the new nodes are not integrated into the network, he will know that the old node that was manipulated by the OOB message must have been a malicious node of an attacker. The operator can repeat the procedure with another old sensor node, but he does not need to be afraid that the attacker could have gained access to the network by the inserted node.

FIG. 2 shows in a scheme a temporal sequence of optical impulses, to which the subset of sensor nodes as explained in the context of FIG. 1d) is exposed. The sensor nodes include a light-sensitive element, which samples the received intensity values at predefined intervals and emits a signal if a threshold intensity is exceeded. The sensor nodes translate the emitted light impulses to a binary sequence of numbers r, wherein a “1” is generated if the light intensity at a given instant is found to be over a threshold intensity, otherwise, a “0” is generated if the threshold intensity has fallen below. In order to generate a shared secret x with well defined length and structure, some kind of normalization function f( ) is applied to the binary sequence of numbers r. In the case shown concretely, this is a hash function h( ).

FIG. 3 shows schematically an example of an embodiment of the authentication process and the agreement on a new key on the base of the shared secret x which was announced to a subset of nodes—as described above—over a secure OOB channel. For reasons of clarity, the processes of authentication and key exchange are illustrated in FIG. 3 with the example of Alice (A) and Bob (B). The depicted situation needs to be transferred to the case of n sensor nodes. For the example being considered the process is always the same, independent of whether it is a new sensor or a sensor that has already been part of the network. Each sensor can hence take the role of Alice or of Bob. In case two sensors already know each other, the application of the protocol is not necessary.

For the purpose of authentication, both Alice and Bob first of all generate a commitment, respectively. In the depicted embodiment a MAC (message authentication code) is applied to the shared secret x, as well as to the product aG (Alice) or bG (Bob). G stands for a generator according to the ECDH algorithm (elliptic curve Diffie-Hellmann), and a and b are random numbers, respectively, with {a, b}εZ. The confirmation is effected by exchange of the public parameters aG for Alice and bG for Bob. The new key S is determined by combining the previously shared secret x with the ECDH exchange, so that S=xdaG=xabG.

For the general case of n nodes, the described method is performed as follows:

First of all, a sensor node N_{S} receives the secret xεZ over the OOB channel. Then, the sensor node N_{S} sends the value MAC(x, kₛG) to all sensor nodes Nᵢ that are within its transmission range. From all the sensor nodes Nᵢ the sensor node S receives in return the values MAC (x, kᵢG). In a next step the sensor node sends the value kₛG to all Nᵢ. For confirmation, this exchange is executed also in the opposite direction, respectively. Finally, all Nᵢ store the value xkₛkᵢG as new key S.

FIG. 4 shows schematically an example of an embodiment of a method according to the invention, wherein sensor nodes are excluded from an existing sensor network. In FIG. 4a) a multitude of sensor nodes is depicted, whereby the values in the clouds attributed to each node represent the corresponding measured values of the sensor nodes. It is assumed that they are, for example, measured temperature values. The sensor node depicted separately is also part of the network, but it does provide inappropriate measured values, for example due to a de-calibration or a bad positioning, and is hence to be excluded from the network.

As already explained several times, a defined information is transferred to the sensor nodes over a secure out of band channel, so the sensor nodes bear a shared secret x. In order to form a new key, the shared secret x is combined with the measured values of the individual sensor nodes. To this end, first of all a value is computed from the measured values m of a node Nⱼ, which in the following will be referred to as evidence E. For the evidence E_{Nj} of a node Nⱼ consequently E_{Nj}=f(m₁, m₂, . . . mₙ) is valid, wherein f can be a function programmed into the node before the initial operation of the network or can be transmitted itself over the OOB channel. The function f can, for example, do a non-linear matching of ranges of measured values on individual values, for example in such a form, that temperature ranges are matched on integers as follows:

f(mᵢ)=1 for mᵢ<20° C.

f(mᵢ)=2 for 20° C. <mᵢ<25° C.

f(mᵢ)=3 for 25° C. <mᵢ<30° C.

f(mᵢ)=4 for 30° C. <mᵢ

Alternatively, f can be a step function, so the evidence is a binary value based on a threshold of the sensed data. Thus, it can be checked, for example, whether a detected intensity of light is above a pre-configurable threshold or not. Alternatively, the function f can also deliver the average value of the last n measurements of a sensor.

If the OOB message is restricted to a relatively small geographic area, the sensors triggered by the message are also positioned relatively close to each other, so the assumption is justified that the expected evidences E for all triggered nodes are within a rather restricted range. If the key distribution with the OOB message x proliferates along with the evidence E, this results in the same key for all nodes with the same evidence. Those nodes that are not able to generate an adequate evidence will not be able to complete the bootstrapping of a new key. The lack of the new key results in that these nodes do no more find access to the network and are hence excluded from it. This is schematically illustrated in FIG. 4b) for the sensor node with the measured value of a temperature of 50.

It has been assumed that the function f is pre-configured in the sensor network, because the individual nodes cannot be handled any more after deployment. Still, a pre-configured function f limits the evidences that can be generated and, consequently, also the exclusion criteria. To avoid this problem the OOB message can be used to transmit, in addition to the shared secret, a separate parameter Oᵢ to the nodes, wherein the parameter includes information regarding the generation of the evidence. In this sense, the parameter can include information like a start of an interval, the width of measurement ranges, the number of measurements that are to be considered for averaging, and the like. In this case the function becomes E_{Nj}=f(O₁, O₂, . . . , Oₙ, m₁, m₂, . . . , mₙ), wherein Oⱼ are the parameters sent along with the OOB message.

In case the described method is applied continuously, the evidence is not used in values that are transmitted over the wireless channel. Consequently, there is no need to perform expensive key exchange protocols. Instead, the sensor nodes can use a key stream based on a current value and a previous value of the key. It is advantageous though to have synchronization points in order to account for glitches in the network and/or missing epochs.

Regarding further advantageous embodiments of the method according to the invention and in order to avoid repetitions, it has to be referred to the general part of the description, as well as to the attached claims.

Finally, it is particularly important to point out that the embodiments of the invention as described above only serve as illustration of the claimed teaching, but that they do by no means restrict the latter to the given examples of an embodiment.

1. A method for operating a wireless sensor network, wherein the sensor network comprises a multitude of sensor nodes for sensing data, the sensor nodes being distributed within a pre-definable environment, and wherein the sensor nodes can exchange information among each other via encrypted data transmissions over a radio channel, characterized in that a subset of sensor nodes of the network is manipulated in order to establish a shared secret (x) by transferring a defined information to the sensor nodes of the subset over a secure out of band (OOB) channel.

2. The method according to claim 1, characterized in that the out of band channel (OOB) is separated logically and/or physically from the radio channel.

3. The method according to claim 1, characterized in that the information is transferred to the subset of sensor nodes by exposing the sensor nodes to a pre-definable temporal sequence of optical and/or acoustic impulses.

4. The method according to claim 1, characterized in that the information is transferred to the subset of sensor nodes by exposing the sensor nodes to a movement.

5. The method according to claim 1, characterized in that the information is transferred to the subset of sensor nodes in form of a sequence of measured values sensed by the sensor nodes.

6. The method according to claim 4, characterized in that the involved sensor nodes translate the sequence of optical and/or acoustic impulses, the movements and/or the sequence of measured values into a binary sequence of numbers (r).

7. The method according to claim 6, characterized in that the binary sequence of numbers (r) is translated into a hash value h(r) that constitutes the shared secret (x) of the manipulated sensor nodes.

8. The method according to claim 1, characterized in that the sensor nodes of the network are informed about an upcoming manipulation by means of a message, which is preferably generated by a sink node of the network.

9. The method according to claim 1, characterized in that for the purpose of integrating new sensor nodes into the network, the manipulation is applied to a subset of sensor nodes of the network—old nodes—, as well as to the sensor nodes to be integrated—new nodes—.

10. The method according to claim 9, characterized in that the manipulation of the new nodes and the old nodes is performed in a controlled environment.

11. The method according to claim 9, characterized in that only one old node is manipulated together with the new nodes.

12. The method according to claim 8, characterized in that the manipulated sensor nodes mutually authenticate based on the shared secret (x).

13. The method according to claim 12, characterized in that the authentication is performed by means of a symmetric message authentication code (MAC) computed on the base of the shared secret (x).

14. The method according to claim 12, characterized in that the manipulated sensor nodes, after having performed authentication on the base of the shared secret (x), agree on a key (S) in the context of a key exchange protocol for a secure data transmission.

15. The method according to claim 14, characterized in that the key exchange is performed according to the Diffie-Hellmann algorithm.

16. The method according to claim 14, characterized in that the key exchange is performed according to a modified Diffie-Hellmann algorithm with simplified public parameters.

17. The method according to claim 1, characterized in that the length of the shared secret (x) is in the range of about 20 bit.

18. The method according to claim 1, characterized in that the information, which is transferred to a subset of sensor nodes over the out of band channel (OOB) in order to generate a new key, is combined with a value—evidence (E)—that is generated by the sensor nodes themselves.

19. The method according to claim 18, characterized in that the evidence (E) is a function (f) of the measured values (m) sensed by the sensor nodes.

20. The method according to claim 18, characterized in that the evidence (E) is a function (f) of measured values sensed by the sensor nodes and of an additional predefined parameter (O).

21. The method according to claim 20, characterized in that the parameter (O) is transmitted to the sensor nodes along with the information transferred over the out of band channel (OOB).

22. The method according to claim 20, characterized in that the parameter (O) refers to the starting time of a measurement interval, to the number of measured values (m) that are to be considered for averaging, or to similar values usable for refinement of exclusion criteria.
